(19) United States
(12) Patent Application Publication
(10) Pub. No.: US 2003/0040648 A1
(43) Pub. Date: Feb. 27, 2003

(54) Triacylglycerol oil-based oligomers and oligomer complexes and methods of making and using same

(76) Inventor: William A. Franks, Kansas City, KS (US)

Correspondence Address: DUNLAP, CODDING & ROGERS P.C., PO BOX 16370, OKLAHOMA CITY, OK, 73114, US

(21) Appl. No.: 10/175,651

(22) Filed: Jun. 19, 2002

Related U.S. Application Data
(60) Provisional application No. 60/299,207, filed on Jun. 19, 2001.
(60) Provisional application No. 60/318,851, filed on Sep. 13, 2001.

(51) Int. Cl. C07C 31/22

(52) U.S. Cl. 568/869

(57) ABSTRACT

The present invention relates in general to triacylglycerol oil-based oligomers and oligomer complexes and methods of making and using same. In more particular, the present invention relates to soybean oil oligomers and oligomer complexes and the methods of making and using these soybean oil oligomers and oligomer complexes as well as the use of these soybean oil oligomers and oligomer complexes for the preparation and production of inks.

### CROSS-REFERENCE TO RELATED APPLICATIONS

This application claims benefit under 35 U.S.C. 119(e) of provisional applications U.S. Serial No. 60/299,207, filed Jun. 19, 2001 entitled “CONTINUOUS FLOW AND BATCH PROCESSES FOR PRODUCTION OF VEGETABLE OIL RESINS AND USES THEREOF,” the contents of which are hereby expressly incorporated in their entirety by reference and provisional application U.S. Serial No. 60/318,851, filed Sep. 13, 2001, entitled “CONTINUOUS FLOW AND BATCH PROCESSES FOR PRODUCTION OF VEGETABLE OIL RESINS AND USES THEREOF,” the contents of which are also hereby expressly incorporated in their entirety by reference.

### BACKGROUND OF THE INVENTION

1. Field of the Invention

The present invention relates in general to triacylglycerol oil-based oligomers and oligomer complexes and methods of making and using same. In more particular, the present invention relates to soybean oil oligomers and oligomer complexes and the methods of making and using soybean oil oligomers and oligomer complexes as well as the use of soybean oil oligomers and oligomer complexes for the preparation and production of inks.

2. Brief Description of the Background Art

Some of the greatest challenges an engineer may face throughout his or her career are the tasks of optimizing existing processes and developing new ones. As the world's population grows exponentially, society must work to conserve natural resources in order to secure our planet for future generations. Engineers have the unique opportunity to make a significant impact with regards to this matter. Such an opportunity exists in the commercial printing industry where traditional ink formulations utilize large amounts of petroleum and petroleum by-products

Domestic production of printing ink exceeds 500 million kilograms per year. Unfortunately, traditional common printing processes result in a strong dependence on one of the Earth's most precious natural resources—petroleum. Traditional printing techniques (such as newsprint) make use of a petroleum-based ink. Several components make up this ink: carbon black pigment (15-20%), hydrocarbons and alkyd resins (15-20%), and mineral oil solvents (50-70%). The latter two of which make up the ink resin and are comprised almost entirely of petroleum and petroleum bi-products. Obviously the volume of ink production in this day and age represents a substantial consumption of petroleum. Additionally, the use of such inks requires the disposal of toxic chemicals and creates a potentially harmful working environment. While the quality of such inks is satisfactory, the need for a suitable replacement exists. With an understanding and foresight of the potentially harmful implications associated with the continued use of traditional ink formulations, researchers began investigating various oil mixtures as alternatives to petroleum oil twenty years ago. As nations, organizations, and individuals seek and develop measures to protect our ever-changing world, one cannot look past the possibility of lessening the dependence on non-renewable resources.

In the early 1980's the American Newspaper Publishers Association (ARPA) devoted extensive research to developing a non-petroleum-based ink vehicle for use in newspaper printing. This movement stemmed from an increasingly volatile petroleum market accompanied by growing environmental concerns. A research committee outlined a number of aspects involved in selecting ink for newsprint presses. Typically, petroleum products make up the resin, or carrier portion of the ink. These resins act as the vehicle to disperse the pigment into the printing medium. A major quality concern centers on the ink carrier's ability to transport and allow the pigment to adsorb onto the surface of the newsprint. This directly affects the clarity and crispness of a print job. In addition, the amount of ruboff on hands and clothing relates to this issue. Another significant concern involves the ability to remove the ink from the press after printing.

The ANIPA first developed several ink carrier formulations consisting of a blend of gilsonite and tall oil fatty acids. They mixed this resin with a carbon black pigment in order to form a useable printing ink. Industry acceptance of these inks suffered, however, due to the cost and availability of tall oil and the difficulty associated with the equipment cleanup caused by gilsonite. In 1987, the ANIPA developed a vegetable oil-based ink carrier made up of refined vegetable oils and a hydrocarbon resin. The triacylglycerol oil class encompasses a number of different constituents including: soybean, cottonseed, canola, sunflower, and safflower oils. Ultimately, the research focused on soybean oil due to the fact that it is the highest volume triacylglycerol oil produced in the United States and the world. In addition, soybean oil is widely available for reasonable prices from agricultural processors such as Archer Daniels Midland, Unfortunately, inks produced in this manner still utilize petroleum products in order to formulate the hydrocarbon resin. Due to the fact that the hydrocarbons only make up about 20% of the ink, these formulations are favorable in comparison to traditional printing inks. While commercial use of these inks in color printing applications exists, black ink use suffers due to increased costs. Thus, the printing industry has continued to seek triacylglycerol oil-based non-petroleum inks.

In 1991, U.S. Pat. No. 5,122,188 outlined the development of an ink carrier comprised of 100% soybean oil. However, several problems arose as a result of scaling up the process for commercialization. This particular procedure involves utilizing nitrogen gas to create an environment for use in changing the fatty acid structure of soybean oil. The problems associated with this method include high material and production costs (i.e. utilizing a nitrogen atmosphere), environmental waste, and a lengthy press drying time.

### SUMMARY OF THE INVENTION

The present invention relates in general to triacylglycerol oil-based oligomers and oligomer complexes and methods of making and using same. In more particular, the present invention relates to soybean oil oligomers and oligomer complexes and the methods of making and using soybean oil oligomers and oligomer complexes as well as the use of soybean oil oligomers and oligomer complexes for the preparation and production of inks.

### BRIEF DESCRIPTION OF THE SEVERAL VIEWS OF THE DRAWINGS

FIG. 1 is a schematic diagram of the process in accordance with the presently claimed and disclosed invention.

FIG. 2 is a schematic diagram of one step of the process in accordance with the presently claimed and disclosed invention.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for purpose of description and should not be regarded as limiting.

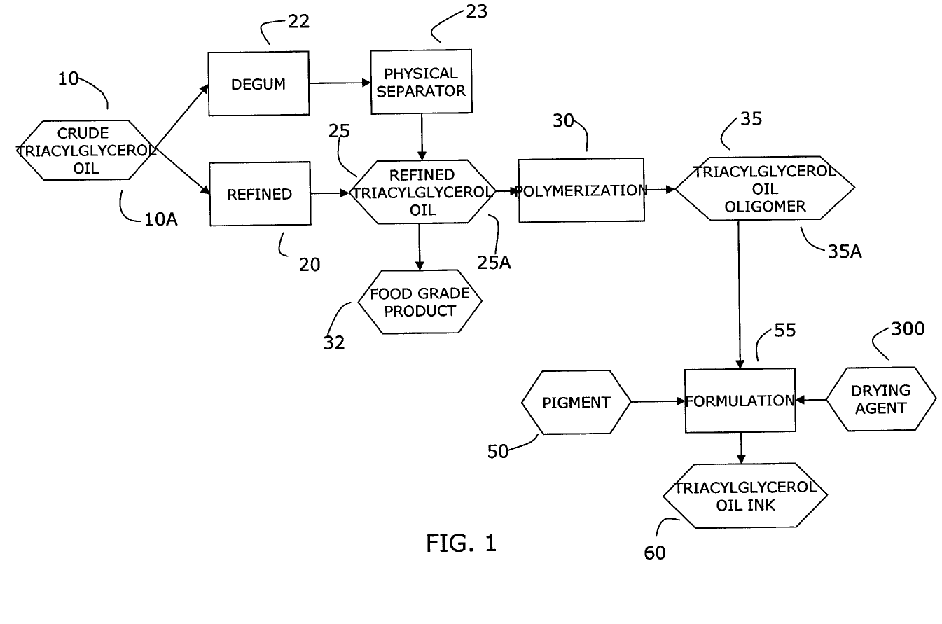

The presently claimed and disclosed invention relates, in general, to triacylglycerol oil oligomers and oligomer complexes that may be used as a resinous carrier for pigments which, together, form a triacylglycerol oil oligomer ink. The methodology for the production of such triacylglycerol oil oligomer inks is shown schematically in FIG. 1. Crude triacylglycerol oil 10 (such as soybean oil, cottonseed oil, canola oil, sunflower oil, and safflower oil, to name but a few as examples and so as not to be limited thereto) is refined using a refining process 20 into a refined triacylglycerol oil 25.

The extraction of the crude triacylglycerol oil 10 from the vegetable or vegetable seed (e.g. soybean or sunflower seed) may occur via solvent extraction or pressing methods that are readily known to those of ordinary skill in the art. Refinement of the crude triacylglycerol oil 10 involves the removal of the gums, waxes, and free fatty acids from the crude triacylglycerol oil 10 to thereby produce the refined triacylglycerol oil 25 which is thereafter polymerized utilizing a polymerization process 30. Refined triacylglycerol oil 25 generally undergoes additional steps such as bleaching, deodorization, and partial hydrogenation and thereafter finds use in the manufacturing of margarine and shortening—i.e. food grade products 32.

The refinement of crude triacylglycerol oil 10 for eventual use in printing ink applications is essential. Failure to refine the crude triacylglycerol oil 10 interferes with the desirable hydrophobic characteristics of final triacylglycerol oil oligomer 35 produced. As an example of a crude triacylglycerol oil 10, crude soybean oil consists of a number of different fatty acids. The most prevalent fatty acids in crude soybean oil are linoleic acid (18:2) and oleic acid (18:1), wherein X:Y refers to X being the number of carbon atoms and Y being the number of double bonds present in each fatty acid.

In addition to refinement of the crude triacylglycerol oil 10, the crude triacylglycerol oil 10 can also be “degummed” via a degumming process 22 to remove the gums and waxes. When degumming the crude triacylglycerol oil 10 to obtain the refined triacylglycerol oil 25, an additional step—i.e. a physical separation via a physical separation process 23 of the free fatty acids from the degummed crude triacylglycerol oil 10 is required. The physical separation process 23 may be a vacuum distillation process or any other process known in the art that is capable of separating the remaining free fatty acid contaminants from the crude triacylglycerol oil 10 that has been degummed. In order to degum the crude triacylglycerol oil 10, a method such as the one disclosed in co-pending U.S. application Ser. No. 09/732,361, entitled “TRIACYLGLYCEROL OLIGOMER PRODUCTS AND METHODS OF MAKING SAME”, filed Dec. 7, 2000, the contents of which are hereby expressly incorporated herein by reference in their entirety, may be used. In any event, the starting material for the present invention is a refined triacylglycerol oil 25 in which the gums, waxes, and free fatty acids have been removed either by the refining process 20, or by the degumming process 22 followed by the physical separation process 23, as shown in FIG. 1.

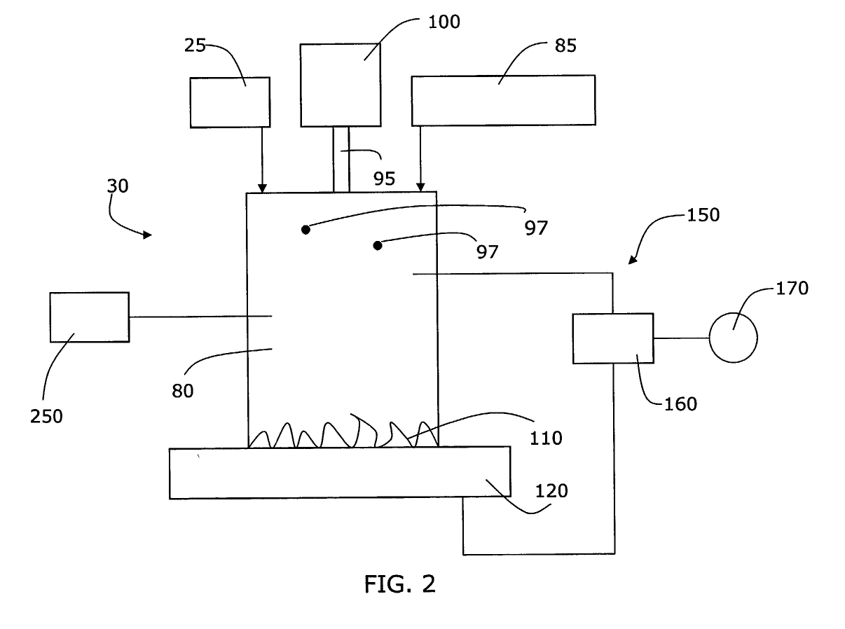

The refined triacylglycerol oil 25 thereafter is polymerized to form the triacylglycerol oil oligomer 35. The triacylglycerol oil oligomer 35 can also be classified as a polymer, resin, or carrier material. The triacylglycerol oil oligomer 35 may be produced in either a batch or continuous flow process—i.e. the polymerization process 30 may be conducted in either a batch or continuous flow process. With either a batch or continuous flow process, the polymerization process 30 includes four general steps that are shown generally in FIGS. 1 and 2: (1) the addition of the refined triacylglycerol oil 25 to a reaction vessel 80; (2) the addition of a complexing agent 85 to the reaction vessel 80; (3) providing a vacuum on the reaction vessel 80 with a vacuum source 100; and (4) heating the reaction vessel 80 via a heating source 120.

Processing the refined triacylglycerol oil 25 requires the breaking and reforming of carbon bonds thereby allowing for the formation of large fatty acid chains. The increase in molecular size (i.e. the formation of large fatty acid chains) directly relates to an increase in the triacylglycerol oil oligomer's 35 viscosity (i.e. as the refined triacylglycerol oil 25 is polymerized via the polymerization process 30, the resulting triacylglycerol oil oligomer 35 has an increased viscosity as compared to the refined triacylglycerol oil 25). The viscosity of the triacylglycerol oil oligomer 35 determines the ability of the triacylglycerol oil oligomer 35 to disperse a pigment 50 onto any desired printing medium—i.e a printing medium with or without any coating. High gloss printing medium applications require triacylglycerol oil oligomer 35 having a high viscosity, while standard printing medium applications only require that the triacylglycerol oil oligomer 35 have a lower viscosity. It is believed that a thermal polymerization reaction accomplishes the desired increase in fatty acid chain length—i.e that such a thermal polymerization reaction accomplishes the polymerization process 30 of the refined triacylglycerol oil 25 into the triacylglycerol oil oligomer 35.

Initiation of polymerization of the refined triacylglycerol oil 25 into the triacylglycerol oil oligomer 35 occurs via the polymerization process 30 by the addition of heat 110 from the heating source 120 under a vacuum 95 created by the vacuum source 100 and in the presence of the complexing agent 85. The degree of polymerization of the refined triacylglycerol oil 25 depends on the time of the reaction (reaction residence time) and the reaction temperature maintained during the polymerization process 30. Viscosity increases are directly proportional to the extent of the polymerization of the refined triacylglycerol oil 25 into the triacylglycerol oil oligomer 35. For example, a temperature 340° C. and a reaction time of from about 5 minutes will produce the triacylglycerol oil oligomer 35 of at least Z10 (based on the Gardner-Holdt viscosity measurement scale)—i.e. of at least 1000 poise.

The vacuum 95 created by the vacuum source 100 is necessary to remove oxygen 97 in the reaction vessel 80 during polymerization of the refined triacylglycerol oil 25 via the polymerization process 30. If oxygen 97 remains in the reaction vessel 80 during polymerization, the refined triacylglycerol oil 25 has a tendency to burn and/or smoke thereby imparting non-desirous properties to the triacylglycerol oil oligomer 35, such as dark color (thereby obscuring any color thereafter added to it), low molecular weight, and low viscosity triacylglycerol oil oligomers 35. The addition of the heat 110 from the heating source 120 is also critical to the initiation of polymerization of the refined triacylglycerol oil 25. The amount of heat 110 required for complete polymerization is proportional to the time required for complete polymerization. For example, if the reaction vessel 80 and contents are heated to 250° C., the time for the polymerization of the refined triacylglycerol oil 25 into the triacylglycerol oil oligomer 35 would be much greater than that if the reaction vessel 80 and contents were heated to 340° C. At 340° C. the time for polymerization of the refined triacylglycerol oil 25 is from about 5 minutes to about 30 minutes, whereas at 250° C. the time for polymerization may be from about 12 hours to 36 hours. Thus, there are advantageous to having the polymerization occur at temperatures of at least 300° C.—although, one of ordinary skill in the art could appreciate the fact that polymerizations at lower temperatures may be advantageous in certain circumstances (i.e. confined operating parameters, combustible conditions etc.) Additionally, the heating source 120 may be any device capable of providing heat to the reaction vessel 80, such as a band heater, circulation heater, and/or jacketed heaters to name but a few as examples and yet as to be not limiting. The heating source 120 should not be considered limited to such example. However, as one of ordinary skill in the art would appreciate and contemplate that any mechanism capable of generating and providing heat 110 to the reaction vessel 80 is contemplated for use.

As mentioned above, the polymerization of the refined triacylglycerol oil 25 takes place in the presence of a complexing agent 85. It should be particularly noted that the complexing agent 85 is not a catalyst: rather, the complexing agent 85 becomes an integral part of the triacylglycerol oil oligomer 35 during polymerization. The complexing agent 85 may be any alkaline earth metal from Group IIa of the periodic chart (e.g. Ca, Mg, or Ba etc.) or a Group VIII element of the periodic chart (e.g. Fe, Co, or Ni etc.) In use, the complexing agent 85 may be a compound such as Ca(OH)₂ or any other hydroxide or other compound capable of complexing the metal of interest with the refined triacylglycerol oil 25. In one preferred embodiment of the present invention, the complexing agent 85 is Ca(OH)₂. The complexing agent 85 is selected on the basis of its ability to reduce or lower the activation energy required for polymerization of the refined triacylglycerol oil 25—i.e. the use of complexing agent 85 reduces the temperature required for polymerization (with longer reaction times) or reduces the reaction times (with higher temperature). It is contemplated that the complexing agent 85 be from about 0.01% to about 30% weight percent, and more preferably from about 0.01% to about 10% weight percent, and even more preferably from about 0.01% to about 3%weight percent, based upon the weight of the refined triacylglycerol oil 25. In one specific example, polymerization of refined soybean oil occurred in a stainless steel reaction vessel 80 at 340° C. under vacuum with the addition of from about 1.1% to about 1.2% weight percent Ca(OH)₂ (i.e.—the complexing agent 85) which polymerized the refined soybean oil into the soybean triacylglycerol oil oligomer having a viscosity of from about Z10 (i.e. 1,000 poise) at room temperature.

The reaction vessel 80 may be fabricated from any material capable of receiving the refined triacylglycerol oil 35 and complexing agent 85 and thereafter allowing polymerization of the refined triacylglycerol oil 25 into the triacylglycerol oil oligomer 35 at elevated temperature and under a vacuum 95. Thus, the reaction vessel 80 may be fabricated from glass, carbon steel, stainless steel (such as SS 304L or 316L), polymer, ceramic, and/or any other material or combination of material that satisfy the functional limitations described hereinabove for the reaction vessel 80. In a preferred embodiment, the reaction vessel 80 is fabricated from stainless steel. It is also preferred in another embodiment that if a material other than stainless steel is used for the reaction vessel 80, that an iron source (e.g. stainless steel chips) be provided. The addition of Fe²⁺ ions to the polymerization has an advantageous effect upon the polymerization of the refined triacylglycerol oil 25 into the triacylglycerol oil oligomer 35. The addition of Fe²⁺ may be accomplished through the type of reaction vessel 80 (i.e. stainless steel) used or through the addition of Fe²⁺ by artificial means into a non-iron reaction vessel 80 (i.e. the addition of stainless steel chips to a glass reaction vessel 80).

Following the completion of polymerization the triacylglycerol oil oligomer 35 possesses the necessary properties required to disperse and/or carry the pigment 50 and thereby formulate 55 a triacylglycerol oil ink 60. The triacylglycerol oil ink 60 has been described herein as a batch process reactor configuration, however, one of ordinary skill in the art would appreciate that the triacylglycerol oil ink 60 may be made in a continuous flow process as well. The need for petroleum products is completely eliminated by the presently claimed and disclosed process that produces the triacylglycerol oil oligomer 35.

As an example of the methodology of the presently claimed and disclosed invention, an example and experimental results confirming the validity of the methodology is hereafter given in terms based upon the daily polymerization 30 of 1500 gallons of a triacylglycerol oil oligomer 35 such as a soybean oil oligomer 35A. In order to produce a triacylglycerol oil oligomer 35 such as a soybean oil oligomer 35A suitable for use in soy inks, crude soy oil is taken through two separate processes: (1) a degumming process 22 (including the physical separation process 23—such as the degumming process disclosed in co-pending U.S. application Ser. No. 09/732,361) or a refining process 20 and (2) a polymerization process 30.

The process flow diagram shown in FIG. 1 shows the entire resin preparation process—i.e. both the degumming process 22/refining process 20 and the polymerization process 30. The crude soybean oil 10A is stored in a 6000 gallon agitated tank, such as a tank made of stainless steel, although the tank may be made out of any material such as glass, polymer, synthetic laminates, ceramics, i.e. any material capable of holding the crude oil and performing the degumming 22 or refining 20 processes. For each batch degumming 22, 190 gallons of the crude soybean oil 10A is pumped into a 200 gallon mixing tank, heated to 40° C., and agitated for 10 minutes. The temperature of the crude soybean oil 10A in the 200 gallon mixing tank must be kept above 40° C. to encourage dispersion but below 80° C. to avoid dissolving hydratable phospholipids. The crude soybean oil 10A is then mixed with 3.6 gallons of water and agitated for 20 minutes and lecithin is extracted from the oil into the aqueous phase. The contents of the mixing tank are then pumped through the centrifuge separating the aqueous lecithin from the crude soybean oil 10A, to thereby provide a refined triacylglycerol oil 25A. The centrifugation method reduces the lecithin level of the refined triacylglycerol oil 25A, reported as residual phosphorous, to less than 200 ppm. Each batch requires roughly 1 hour to process through the mixing tank and centrifuge. Eight batches per day require 29 gallons of water and 1521.5 gallons of crude soybean oil 10A. Each day, 1521 gallons of refined soybean oil 25A are produced by removing 2.3 pounds of lecithin. The refined soybean oil 25A is stored in a 1500 gallon holding tank awaiting polymerization of the refined soybean oil 25A into soybean oil oligomer 35A.

The polymerization of the refined soybean oil 25A (or the refined triacylglycerol oil 25) is also described herein as a batch process but one of ordinary skill in the art would appreciate that the polymerization may also take place as a continuous flow process and that the presently claimed and disclosed invention is intended to encompass polymerization 30 that occur in either a batch of continuous flow manner. Each day, the entire contents (i.e. the refined triacylglycerol oil 25 or the refined soybean oil 25A) of the holding tank are pumped into a 1500 gallon, reaction vessel 80. A complexing agent 85 (CA(OH₂)) is added to the refined soybean oil 25A (or the refined triacylglycerol oil 25) in the reaction vessel 80 and a vacuum 95 is thereafter placed onto the reaction vessel 80. Heat 110 is thereafter applied to the reaction vessel 80 and its contents and polymerization of the refined soybean oil 25A into the soybean oil oligomer 35A occurs. The resulting soybean oil oligomer 35A may also be thought of as a soybean oil oligomer 35A complexed with the metal (i.e. Ca of the complexing agent 85. Changing the metal of the complexing agent 85 (i.e. instead of Ca) changes the resulting color or tint of the soybean oil oligomer 35A. If Co is substituted for Ca in the complexing agent 85, the soybean oil oligomer 35A has a blue color or tint to it. If the metal of the complexing agent 55 is Ca, the resulting soybean oligomer 35A is clear or nearly colorless.

The reaction time is automatically controlled by a recycle loop 150 containing a viscometer 160 and controller 170 that can be set at the desired viscosity. When the desired viscosity of the soybean oil oligomer 35A has been reached, heat 110 is removed and the soybean oil oligomer 35A is allowed to return to ambient or room temperature and pumped into a 6000 gallon, agitated product storage tank. Each daily batch removes 23 pounds of moisture and volatiles and 116 pounds of free fatty acid to produce the desired 1500 gallons of soybean oil oligomer 35A per day.

The process of the presently claimed and disclosed invention produces 11460 pounds of soybean oil oligomer 35A daily based upon the given reactor sizes. Of course, one of ordinary skill in the art would be capable of scaling the above-described methodology up to increase the daily soybean oil oligomer 35A produced. The crude soybean oil 10A is delivered to the processing plant with impurities such as gums, waxes and free fatty acids. The degumming 22 or refining 20 processes remove these impurities as well as remove the gums, waxes, or other fatty acids, such as lecithin.

The utilities required for presently methodology include water for the degumming 22 or refining 20 processes and electricity or steam to produce the heat 110 in the reactors such as the reacting vessel 80. The water used in the degumming 22 or refining 20 processes should be distilled to ensure purity and avoid outside contamination with the crude soybean oil 10A. The major use of electricity will be to raise the temperature of the reaction vessel 80 during polymerization 30 resulting in the use of approximately 96,000 kilowatt hours per year.

The most significant safety focus in the preparation of the soybean oil oligomer 35A is the prevention of combustion in the reaction vessel 80. Because the polymerization of the refined soybean oil 25A (or refined triacylglycerol oil 25) is carried out at high temperatures, the removal of oxygen 97 and other volatiles in the reaction vessel 80 via vacuum 95 is vital. To ensure a low level of oxygen 97, an optional oxygen sensor 250 may be used in order to ensure that a temperature of 180° C. should be maintained until the oxygen 97 levels are low enough in the reaction vessel 80 to continue with polymerization.

As mentioned hereinabove, the triacylglycerol oil oligomer 35 (or soybean oil oligomer 35a) can be used to formulate 55 inks. In one embodiment, the triacylglycerol oil oligomer 35 is formulated 55 with the pigment 50 to thereby produce a 100% triacylglycerol oil ink 60. The pigment 50 may be any type of pigment, for example carbon black or earth pigments such as raw sienna, raw umber, burnt umber and etc. Additionally, other pigments such alkali blue, calcium vubine, and phthalo blue may be used as pigment 50 in the formulation 55 of the triacylglycerol oil ink 60.

In order to decrease the drying time of the triacylglycerol (soybean) oil ink 60 (which may be a significant period of time) on printed mediums, a drying agent 300 may be added in the formulation 55 step of the production of the triacylglycerol oil ink 60. The drying agent may be any compound capable of increasing the absorption rate and/or the oxidation rate of the triacylglycerol oil ink 60 when applied to a printing medium. For example, the drying agent 300 may be cobalt acetate or japan driers. In order to produce a 100% triacylglycerol oil ink 60, however, the drying agent may preferably be an amount of crude triacylglycerol oil 10 (such as crude soybean oil 10a) added to the triacylglycerol oil oligomer 35 (such as soybean oil oligomer 35a) in the formulation 55 step. Additionally, the drying agent 300 may be an amount of refined 20 or degummed 22 triacylglycerol oil 25 (such as refined soybean oil 25a). The addition of the drying agent 300 reduces the need for external heat application to the coated printing medium used with the triacylglycerol oil ink 60 of the present invention. In a preferred embodiment, the amount of crude triacylglycerol oil 10 or refined triacylglycerol oil 25 added to the triacylglycerol oil oligomer 35a in the formulation step 55 is from about 10 to about 60% based upon the total weight of the triacylglycerol oil ink 60 formulation. Even more preferred, the amount of crude triacylglycerol oil 10 or refined triacylglycerol oil 25 added to the triacylglycerol oil oligomer 35a in the formulation step 55 is from about 30% to about 50% based upon the total weight of the triacylglycerol oil ink 60 formulation. In an additional preferred embodiment, the ration of triacylglycerol oil oligomer 35 to drying agent 300 is 70%:30% based upon the total weight of the triacylglycerol oil ink. Thus, utilizing a triacylglycerol oil ink 60 of the presently claimed and disclosed invention results in the practitioner no longer needing to heat set the ink when using coated printing mediums. Thus, a significant economic and time-saving advantage is realized in utilizing the triacylglycerol oil ink 60 of the presently disclosed and claimed invention.

Generally, the triacylglycerol oil ink 60 of the presently claimed and disclosed invention would contain three main components: (1) a pigment 50: such as carbon black flush (for black inks) or earth or synthetic pigments (for colored inks); (2) triacylglycerol oil oligomer 35; and (3) a drying agent 300. In addition to these three main components, the triacylglycerol ink 60 may also contain additional additives that are used to optimize the triacylglycerol oil ink 60 for process printing or other techniques. For example, clay may be added as a rheological agent to decrease the misting qualities of the triacylglycerol oil ink 60 and to increase its viscosity even further; and wetting agents may be added to make the pigment 50 capable of being ground or to allow the triacylglycerol oil ink 60 to be able to pick up more water for offset printing processes. A specific example of such a triacylglycerol ink 60 with additives is shown in Table I.

TABLE I
Triacylglycerol Oil Ink Formula

| Component | Weight percent |
|---|---|
| Carbon Black Flush | 68.2% |
| (60% Triacylglycerol Oil Oligomer: | |
| 40% Carbon Black) | |
| Bentone 128 | 3.0% |
| (Clay - Rheological agent) | |
| Triacylglycerol Oil Oligomer | 15.0% |
| (Soybean oil oligomer) | |
| Stearic Acid | 1.0% |
| (Wetting Agent) | |
| Refined Triacylglycerol Oil | 12.1% |
| (Refined soybean oil) | |
| Methyl Linoleate | 0.7% |
| (Wetting agent) | |

Thus, it should be apparent that there has been provided in accordance with the present invention triacylglycerol oil-based oligomers and oligomer complexes and methods of making and using same, that fully satisfies the objectives and advantages set forth above. Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

What I claim is:

1. A triacylglycerol oil oligomer produced according to a process comprising the steps of:
refining crude triacylglycerol oil to produce a refined triacylglycerol oil; and
polymerizing the refined triacylglycerol oil to produce a triacylglycerol oil oligomer.

2. The triacylglycerol oil oligomer of claim 1, wherein the crude triacylglycerol is a crude soybean oil.

3. The triacylglycerol oil oligomer of claim 1, wherein in the step of refining the crude triacylglycerol oil to produce a refined triacylglycerol oil, the refining step is a degumming process wherein gums and waxes are removed from the crude triacylglycerol oil.

4. The triacylglycerol oil oligomer of claim 1, wherein the polymerizing step occurs under a vacuum.

5. The triacylglycerol oil oligomer of claim 1, wherein in the polymerizing step, a complexing agent is added to the refined triacylglycerol oil.

6. The triacylglycerol oil oligomer of claim 5, wherein the complexing agent is a Group II or Group VIII metal compound.

7. The triacylglycerol oil oligomer of claim 6, wherein the complexing agent is Ca(OH)₂.

8. The triacylglycerol oil oligomer of claim 1, wherein the polymerizing step is conducted at a temperature of from 200° C. to about 360° C.

9. The triacylglycerol oil oligomer of claim 1, wherein the polymerizing step is conducted at a temperature of 340° C., Ca(OH)₂ is added to the refined triacylglycerol oil, and the polymerizing step is conducted under a vacuum.

10. A method for producing a triacylglycerol oil oligomer, comprising the steps of:
refining crude triacylglycerol oil to produce a refined triacylglycerol oil; and
polymerizing the refined triacylglycerol oil to produce a triacylglycerol oil oligomer.

11. The method of claim 10, wherein the crude triacylglycerol is a crude soybean oil.

12. The method of claim 10, wherein in the step of refining the crude triacylglycerol oil to produce a refined triacylglycerol oil, the refining step is a degumming process wherein gums and waxes are removed from the crude triacylglycerol oil.

13. The method of claim 10, wherein the polymerizing step occurs under a vacuum.

14. The method of claim 10, wherein in the polymerizing step, a complexing agent is added to the refined triacylglycerol oil.

15. The method of claim 14, wherein the complexing agent is a Group II or Group VIII metal compound.

16. The method of claim 15, wherein the complexing agent is Ca(OH)₂.

17. The method of claim 10, wherein the polymerizing step is conducted at a temperature of from 200° C. to about 360° C.

18. The method of claim 10, wherein the polymerizing step is conducted at a temperature of 340° C., Ca(OH)₂ is added to the refined triacylglycerol oil, and the polymerizing step is conducted under a vacuum.

19. A triacylglycerol oil ink, comprising:
an amount of triacylglycerol oil oligomer; and
an amount of a pigment.

20. The triacylglycerol oil ink of claim 19, wherein the triacylglycerol oil oligomer is produced according to the method of claim 10.

21. The triacylglycerol oil ink of claim 19, further including a drying agent.

22. The triacylglycerol oil ink of claim 21, wherein the drying agent is crude triacylglycerol oil or refined triacylglycerol oil.
